(19) United States
(12) Patent Application Publication
(10) Pub. No.: US 2012/0167196 A1
(43) Pub. Date: Jun. 28, 2012

(54) Automatic Virtual Private Network

(75) Inventors: Gerald D. Colar, Atlanta, GA (US); Melanie R. Diggs, (US); John W. Miller, Suwanee, GA (US); Charles K. Young, Powder Springs, GA (US)

(73) Assignee: INTERNATIONAL BUSINESS MACHINES CORPORATION, Armonk, NY (US)

(21) Appl. No.: 12/978,021

(22) Filed: Dec. 23, 2010

(51) Int. Cl. G06F 17/00

(52) U.S. Cl. 726/15

(57) ABSTRACT

An embodiment of the invention provides a method for secure access to data a VPN. Parameters for connecting to the VPN are established by a VPN manager connected to a local network and a user connected to a remote network, wherein an automatic VPN identification number is generated based on the parameters. A remote IP address is installed on an automatic VPN device of the user. The automatic VPN identification number is tied to an access list; and, the access list is attached to the automatic VPN device of the user. A request to access the VPN is received from the user. Access to the VPN is provided through a secure encryption tunnel if the request includes the automatic VPN identification number. The secure encryption tunnel provides automatic access to multiple sites within the VPN without the user having to re-enter the automatic VPN identification number.

### BACKGROUND

The present invention is in the field of methods, systems, and computer program products for an automatic virtual private network (VPN).

A VPN is an extension of a private intranet network across a public network, such as the Internet, creating a secure private connection. A VPN securely conveys information across the Internet connecting remote users, branch offices, and business partners into an extended corporate network. This effect is achieved through a secure encryption tunnel, which allows a private network to send data via a public network's connections. The secure encryption tunnel encapsulates a network protocol within packets carried by the public network. The data sent between two locations via the secure encryption tunnel cannot be read by anyone else.

### SUMMARY OF THE INVENTION

An embodiment of the invention includes a method for secure access to data from a remote location through a VPN. Parameters for connecting to the VPN are established by a VPN manager connected to a local network and a user connected to a remote network, wherein an automatic VPN identification number is generated based on the parameters. A remote IP address is installed on an automatic VPN device of the user. The automatic VPN identification number is tied to an access list; and, the access list is attached to the automatic VPN device of the user.

A request to access the VPN is received from the user. Access to the VPN is provided through a secure encryption tunnel if the request includes the automatic VPN identification number. The secure encryption tunnel provides automatic access to multiple sites within the VPN without the user having to re-enter the automatic VPN identification number.

Another embodiment of the invention includes a system for secure access to data from a remote location through a VPN. The system includes a local automatic VPN device and a remote automatic VPN device. The local automatic VPN connects a local network to a public network; and, the remote automatic VPN device connects a remote network to the public network. The remote automatic VPN device includes storage for storing an automatic VPN identification number generated based on connection parameters agreed to by the local automatic VPN device and the remote automatic VPN device. The local automatic VPN device and the remote automatic VPN device includes a secure encryption tunnel for providing access to the local network by the remote network if the remote automatic VPN device includes the automatic VPN identification number.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a system for secure access to data from a remote location through a VPN according to an embodiment of the invention

FIG. 2 is a flow diagram illustrating a method for establishing connection parameters between a network engineer and a client according to an embodiment of the invention;

FIG. 3 is a flow diagram illustrating a method for secure access to data from a remote location through a VPN according to an embodiment of the invention; and

FIG. 4 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention allows users a secure way to automatically access files, databases, and other data at remote locations through an automatic VPN. Once an encryption domain is authenticated once, all instances of the VPN environment have the ability to automatically access remote files without further authentication through a secure encryption tunnel. Therefore, a physical person is not required to manually authenticate a user ID and password in order for a user to access files at a remote location.

In at least one embodiment of the invention, a network engineer (e.g., the VPN administrator) inputs a peer IP address (also referred to herein as a “remote IP address”) into the VPN connectivity device at the client's location. Once the peer IP address is input, a negotiation takes place with the VPN connectivity device of the client network.

The connection automatically negotiates the Phase 1 Internet Security Association and Key Management Protocol (ISAKMP) information and Phase 2 Internet Protocol Security (IPSEC) data. In Phase 1 processing, each party (e.g., the network engineer and the client), establishes an ISAKMP security association to use in securing information sent between the computer systems. In Phase 2 processing, each system creates IPSEC security associations for securing data traffic sent between the systems by negotiating one or more security associations and the systems exchange IP addresses by using phased IDs and policies.

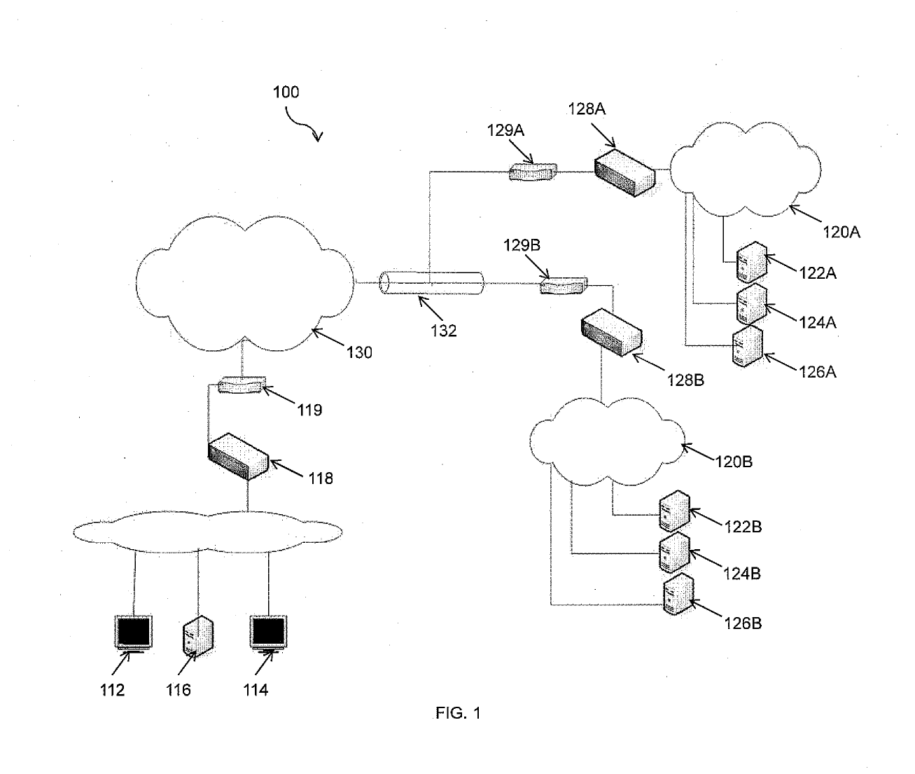

FIG. 1 illustrates a system for providing secure access to data from a remote location according to an embodiment of the invention. More specifically, data from a local network 110 is accessed by users connected to remote networks 120A and/or 120B. In another embodiment, the system 100 only includes one remote network. In yet another embodiment, the system 100 includes more than two remote networks. The data is stored on user machines 112, 114, and/or a local server 116 connected to the local network 110. A local automatic VPN device 118 connects the local network 110 to the Internet 130 via a router 119.

The data is accessed by users connected to remote servers 122A, 124A, 126A, 122B, 124B, and/or 126B. Remote automatic VPN devices 128A and 128B connect the remote networks 120A and 120B to the Internet 130, respectively, via routers 129A and 129B, respectively, and an external internet connection 132. The routers 119, 129A, and 129B are IP layer 3 devices that are responsible for sending and receiving data from a remote data network location to another. The external internet connection 132 is the open internet that allows data to be sent to and from one data network location to another.

To establish an automatic VPN connection, network engineers input a peer IP address and a shared ISAKMP key into the automatic VPN devices 118, 128A, and 128B. A negotiation takes place between the local automatic VPN device 118 and the remote automatic VPN devices 128A and 128B. The VPN connection automatically negotiates phase 1 ISAKMP parameters and phase 2 IPSEC parameters at the remote automatic VPN devices 128A and 128B. After an agreed upon negotiation has successfully taken place, the remote automatic VPN devices 128A and 128B automatically create a VPN identification number at remote networks 120A and 120B.

Once the VPN identification number is created, the network engineer ties it to an access list and attaches the access list to the remote automatic VPN devices 128A and 128B. Accordingly, the allowed data traffic flows through the remote automatic VPN devices 128A and 128B without the assistance of a network engineer having to manually input VPN negotiation parameters.

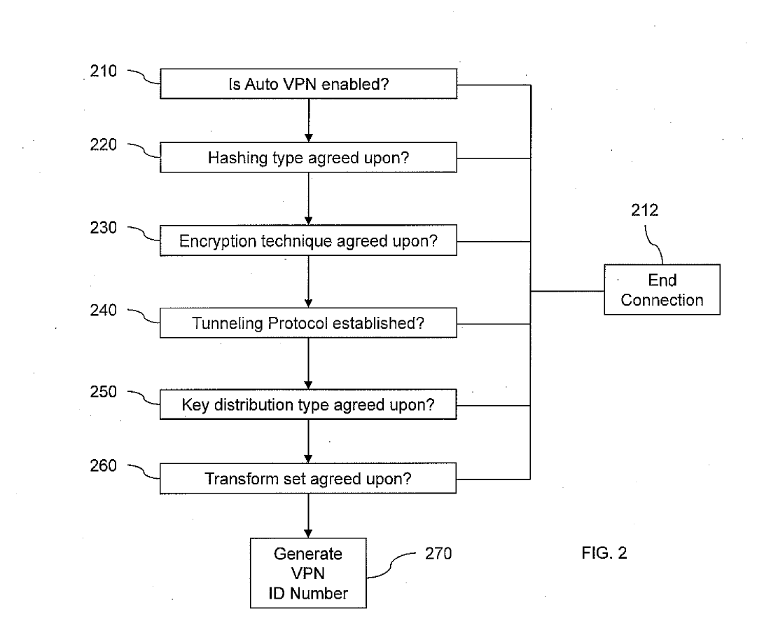

FIG. 2 is a flow diagram illustrating a method for establishing connection parameters between a network engineer (also referred to herein as the “VPN manager”) and a client (also referred to herein as the “user”) according to an embodiment of the invention. In at least one embodiment, the network engineer and/or client are human individuals or groups of humans. In another embodiment, the network engineer and/or client are non-human system components that include computer hardware and/or software.

Although FIG. 2 illustrates that the items 210, 220, 230, 240, 250, 260, and 270 are performed in numeric order, the items 210, 220, 230, 240, 250, 260, and 270 are performed in a different order in another embodiment of the invention. For example, the tunneling protocol is established before the encryption technique is agreed upon. In another embodiment, one or more of the items 210, 220, 230, 240, 250, 260, and 270 are omitted. For example, the network engineer and client do not negotiate a transform set parameter.

A connectivity module determines whether the automatic VPN is enabled on the VPN connectivity device of the client 210. If the automatic VPN is not enabled, the connection is ended 212—the remote connection must be established manually. If the automatic VPN is enabled, the connectivity module determines whether the type of hashing is agreed upon between the network engineer and the client 220. If the hashing type is not agreed upon, the connection is ended 212.

Hashing ensures that information being transmitted over the automatic VPN is not altered in any way during transit. For example, the network engineer generates a message and a hash of the message. The message and hash are encrypted and sent over the automatic VPN. The client decrypts the message and the hash, and produces another hash from the received message. The two hashes are compared; and, if the hashes are the same, there is a high likelihood that the message was not altered.

If the hashing type is agreed upon, the connectivity module determines whether the encryption technique is agreed upon between the network engineer and the client 230. If the encryption technique is not agreed upon, the connection is ended 212. However, if the encryption technique is agreed upon, the connectivity module determines whether a tunneling protocol has been established between the network engineer and the client 240. If the tunneling protocol has not been established, the connection is ended 212. Computer networks use a tunneling protocol to enable one network (e.g., an organization's LAN) to securely send its data through another network's connections (e.g., the Internet). Tunneling encapsulates a network protocol within packets carried by the second network. For example, the organization's LAN embeds its own network protocol within the TCP/IP packets carried by the Internet.

If the tunneling protocol has been established, the connectivity module determines whether the key distribution type is agreed upon between the network engineer and the client 250. If the key distribution type is not agreed upon, the connection is ended 212. A key is distributed to the client via the automatic VPN, wherein the key is used to decrypt a message. The key distribution type defines the mode in which the key is sent to the client (e.g., use of a trusted courier, use of an existing encryption channel).

If the key distribution type is agreed upon, the connectivity module determines whether the transform set is agreed upon between the network engineer and the client 260. If the transform set is not agreed upon, the connection is ended 212. A transform set is a group of policies that the routers establishing the automatic VPN agree upon. A transform set has three configuration elements: data encryption, data authentication, and encapsulation mode. If the transform set is agreed upon, an automatic VPN ID number is generated 270.

In at least one embodiment of the invention, the user ties the automatic VPN ID number to an access list, wherein the access list is attached to an interface on the VPN connectivity device of the user. In one embodiment, the automatic VPN ID number permits automatic access to multiple VPN partners and client networks. After the access list is attached to the interface, information traffic is able to flow without the assistance of the network engineer. Thus, the network engineer is not required to manually input the VPN exchange data in order for the user to access files at a remote location. In another embodiment, the VPN connectivity device has an existing access list, which is updated by adding the automatic VPN ID number to the access list.

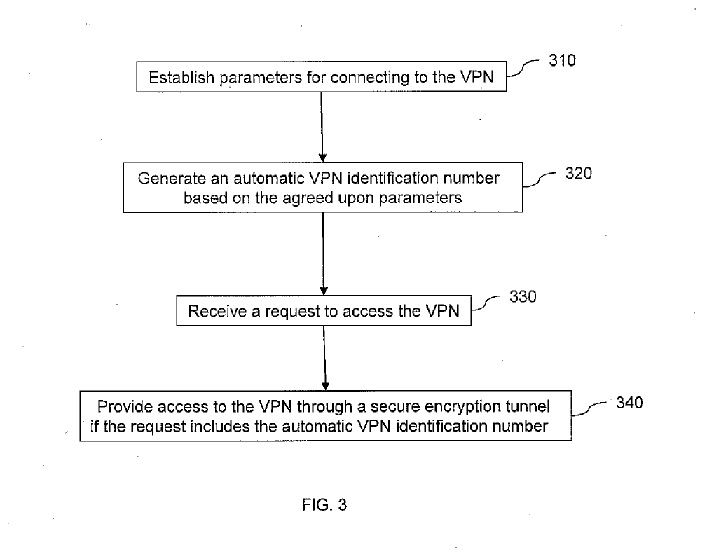

FIG. 3 is a flow diagram illustrating a method for secure access to data (e.g., a local network) from a remote location (e.g., one or more remote networks) through a VPN according to an embodiment of the invention. Parameters for connecting to the VPN are established 310, for example, by a VPN manager connected to the local network (the local automatic VPN device) and a user connected to the remote network (the remote automatic VPN device). More specifically, the parameters include a hashing type, an encryption technique, a tunneling protocol, a key distribution type, a transform set, ISAKMP parameters, and/or IPsec parameters that are negotiated between the local automatic VPN device and remote automatic VPN device.

An automatic VPN identification number is generated based on the agreed upon parameters 320. In at least one embodiment, the automatic VPN identification number is generated by the local automatic VPN device or the remote automatic VPN device. Moreover, the automatic VPN identification number is stored in the local automatic VPN device and the remote automatic VPN device. In at least one embodiment, a remote IP address is installed on the remote automatic VPN device. The automatic VPN identification number is tied to an access list; and, the access list is attached to an interface on the remote automatic VPN device.

A request to access the VPN is received from the user 330, for example, via a graphical user interface. Access to the VPN is provided through a secure encryption tunnel of the VPN if the request includes the automatic VPN identification number 340. In one embodiment, the secure encryption tunnel is provided to the user by an access controller computing module having both hardware and software components.

The secure encryption tunnel provides automatic access to multiple sites within the VPN (e.g., the local network) without the user and/or VPN manager having to re-enter the automatic VPN identification number. In other words, the user does not have to be re-authenticated each time the user accesses a site within the local network. Moreover, connection parameters do not have to be established, negotiated, or manually input each time the user accesses a site within the local network. As described above, access to the VPN includes gateway-to-gateway access and/or firewall-to-firewall access.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

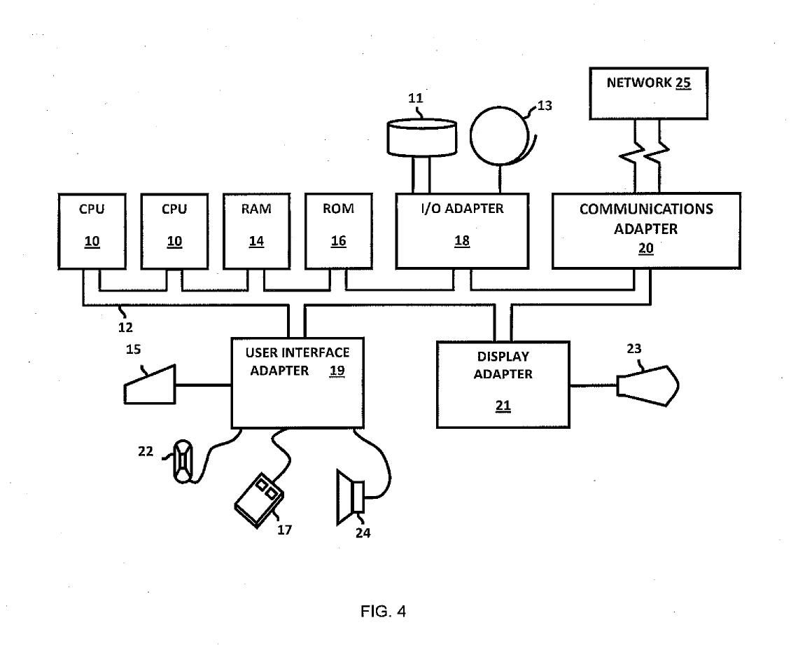

Referring now to FIG. 4, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for secure access to data from a remote location through a virtual private network (VPN), said method including:
establishing parameters for connecting to the VPN;
generating an automatic VPN identification number based on the parameters;
receiving a request to access the VPN from a user at the remote location; and
providing access to the VPN through a secure encryption tunnel if the request includes the automatic VPN identification number, the secure encryption tunnel providing automatic access to multiple sites within the VPN without the user having to re-enter the automatic VPN identification number.

2. The method according to claim 1, wherein the parameters are established by a VPN manager connected to a local network and a user connected to a remote network.

3. The method according to claim 1, further including storing the automatic VPN identification number in a local automatic VPN device connected to a local network and a remote automatic VPN device connected to a remote network.

4. The method according to claim 1, wherein said establishing of the parameters for connecting to the VPN includes establishing at least one of a hashing type, an encryption technique, a tunneling protocol, a key distribution type, and a transform set.

5. The method according to claim 1, wherein said establishing of the parameters for connecting to the VPN includes establishing an internet security association and key management protocol.

6. The method according to claim 1, wherein said establishing of the parameters for connecting to the VPN includes establishing an internet protocol security suite.

7. The method according to claim 1, wherein the access to the VPN includes at least one of gateway-to-gateway access and firewall-to-firewall access.

8. The method according to claim 1, further including:
installing a remote IP address on an automatic VPN device of the user;
tying the automatic VPN identification number to an access list; and
attaching the access list to an interface of the automatic VPN device of the user.

9. A method for secure access to data from a remote location through a virtual private network (VPN), said method including:
establishing parameters for connecting to the VPN by a VPN manager connected to a local network and a user connected to a remote network;
generating an automatic VPN identification number based on the parameters;
installing a remote IP address on an automatic VPN device of the user;
tying the automatic VPN identification number to an access list;
attaching the access list to the automatic VPN device of the user;
receiving a request to access the VPN from the user; and
providing access to the VPN through a secure encryption tunnel if the request includes the automatic VPN identification number, the secure encryption tunnel providing automatic access to multiple sites within the VPN without the user having to re-enter the automatic VPN identification number.

10. The method according to claim 9, wherein said establishing of the parameters for connecting to the VPN includes establishing a hashing type, an encryption technique, a tunneling protocol, a key distribution type, and a transform set.

11. The method according to claim 9, wherein said establishing of the parameters for connecting to the VPN includes establishing an internet security association and key management protocol.

12. The method according to claim 9, wherein said establishing of the parameters for connecting to the VPN includes establishing an internet protocol security suite.

13. A system including:
a local automatic virtual private network (VPN) device for connecting a local network to a public network; and
a remote automatic VPN device for connecting a remote network to the public network, said remote automatic VPN device including storage for storing an automatic VPN identification number generated based on connection parameters agreed to by said local automatic VPN device and said remote automatic VPN device,
said local automatic VPN device and said remote automatic VPN device including a secure encryption tunnel for providing access to said local network by said remote network if said remote automatic VPN device includes the automatic VPN identification number.

14. The system according to claim 13, wherein said secure encryption tunnel provides automatic access to multiple sites within said local network without a user of said at least one remote network having to re-enter the automatic VPN identification number.

15. The system according to claim 13, wherein said local automatic VPN device includes the automatic VPN identification number.

16. The system according to claim 13, wherein the connection parameters include at least one of a hashing type, an encryption technique, a tunneling protocol, a key distribution type, and a transform set.

17. The system according to claim 13, wherein the connection parameters include an internet security association and key management protocol.

18. The system according to claim 13, wherein the connection parameters include an internet protocol security suite.

19. The system according to claim 13, wherein said remote automatic VPN device includes a remote IP address and an access list, wherein the access list is tied to the automatic VPN identification number.

20. A computer program product for secure access to data from a remote location through a virtual private network (VPN), said computer program product including:
a computer readable storage medium;
first program instructions to establish parameters for connecting to the VPN;
second program instructions to generate an automatic VPN identification number based on the parameters;
third program instructions to receive a request to access the VPN from a user at the remote location; and
fourth program instructions to provide access to the VPN through a secure encryption tunnel if the request includes the automatic VPN identification number, the secure encryption tunnel providing automatic access to multiple sites within the VPN without the user having to re-enter the automatic VPN identification number,
said first program instructions, said second program instructions, said third program instructions, and said fourth program instructions are stored on said computer readable storage medium.

21. The computer program product according to claim 20, wherein the parameters are established by a VPN manager connected to a local network and a user connected to a remote network.

22. The computer program product according to claim 20, further including fifth program instructions to store the automatic VPN identification number in a local automatic VPN device connected to a local network and a remote automatic VPN device connected to a remote network.

23. The computer program product according to claim 20, wherein said first program instructions establish at least one of a hashing type, an encryption technique, a tunneling protocol, a key distribution type, and a transform set.

24. The computer program product according to claim 20, wherein said first program instructions establish an internet security association and key management protocol.

25. The computer program product according to claim 20, wherein said first program instructions establish an internet protocol security suite.
